(19) United States
(12) Patent Application Publication
(10) Pub. No.: US 2018/0203896 A1
(43) Pub. Date: Jul. 19, 2018

(54) METHOD AND APPARATUS FOR PROCESSING QUERY

(71) Applicant: ELECTRONICS AND TELECOMMUNICATIONS RESEARCH INSTITUTE, Daejeon (KR)

(72) Inventors: Moonyoung CHUNG, Daejeon (KR); Taewhi LEE, Daejeon (KR); Sung-Soo KIM, Daejeon (KR); Hyewon SONG, Daejeon (KR); Jongho WON, Daejeon (KR)

(73) Assignee: ELECTRONICS AND TELECOMMUNICATIONS RESEARCH INSTITUTE, Daejeon (KR)

(21) Appl. No.: 15/800,762

(22) Filed: Nov. 1, 2017

(30) Foreign Application Priority Data
Jan. 19, 2017 (KR) 10-2017-0009426

(51) Int. Cl. G06F 17/30

(52) U.S. Cl. CPC G06F 17/30442; G06F 17/30333; H04L 67/1097; G06F 17/3033; G06F 17/30625; G06F 17/30492

(57) ABSTRACT

A method and an apparatus for processing a query are disclosed. When the query is input, in a case in which partitions are present in a data table, a partition corresponding to the input query is selected, and in a case in which one or more partition column sets are present in the selected partition, one or more partition column sets corresponding to the input query are selected, and the query is processed for the selected partition column sets.

### CROSS-REFERENCE TO RELATED APPLICATION

This application claims priority to and the benefit of Korean Patent Application No. 10-2017-0009426 filed in the Korean Intellectual Property Office on Jan. 19, 2017, the entire contents of which are incorporated herein by reference.

### BACKGROUND OF THE INVENTION

### (a) Field of the Invention The present invention relates to a method and an apparatus for processing a query.

### (b) Description of the Related Art

In recent years, as a big data processing has been importantly researched, Hadoop, which is an open source project for supporting a parallel processing of massive data has been widely researched. Hadoop includes a hadoop distribute file system (HDFS), which is a platform for distributing, storing, and managing the massive data, and Mapreduce (MR), which is a framework for performing a distributed parallel processing of the massive data, and many techniques for processing a query using Mapreduce have been researched.

A structure query language (SQL)-on-Hadoop is a system providing an SQL query processing for the data stored in the hadoop distribute file system (HDFS). Most of SQL-on-Hadoop systems does not use a Mapreduce architecture provided by conventional Hadoop and is implemented based on a new distribute processing model and framework. Many SQL-on-Hadoop systems such as Apache Hive, Apache Tajo, Impala of Cloudera, Presto of Facebook, and the like are present.

The SQL-on-Hadoop system may distribute and process the query for the massive data which is distributed in a plurality of nodes, but since a plurality of disk inputs/outputs (I/O) and network transmissions are required during an operation of moving the date to the node of processing the query, a query processing speed is slowed down. In order to improve the slow processing speed for the HDFS based distributed data, technologies such as a materialized view, a query column sets, a data partition, and the like are utilized.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and an apparatus capable of further improving a query processing speed.

An exemplary embodiment of the present invention provides a method for processing a query by an apparatus for processing the query, including when the query is input and partitions are present in a data table, selecting a partition corresponding to the input query; when one or more partition column sets are present in the selected partition, selecting one or more partition column sets corresponding to the input query; and processing the query for the selected partition column sets.

When the data table is divided into one or more horizontal partitions, the partition column sets may be data structures in which a column set obtained by grouping one or more columns configuring the data table for each of the horizontal partitions is stored in a cash table.

One or more partition column sets may be selectively formed for each of the partitions of the data table, and the number of formed partition column sets and the kind of columns forming the partition column sets may be different for each of the partitions.

In the selecting of the partition column sets, a conditional clause of the input query may be analyzed and one partition column set of the one or more partition column sets may be selected based on a result of the analysis when the one or more partition column sets are formed for the selected partition.

The method may further include when the partitions are not present in the data table, processing the query for the data table; and when the partition column sets are not present in the selected partition, processing the query for the selected partition.

The apparatus for processing the query may be a distribute query processing engine.

Another embodiment of the present invention provides a method for configuring a column set for processing a query, including analyzing a workload of the query to divide a data table into a plurality of horizontal partitions; and selectively configuring one or more partition column sets obtained by grouping one or more columns configuring the data table, based on a result of the analysis of the workload of the query for each of the horizontal partition.

The number of formed partition column sets may be different for each of the horizontal partitions.

The kind of columns configuring the partition column sets may be different each of the horizontal partitions.

The configuring of the one or more partition column sets may include storing the partition column sets in a cash table.

The configuring of the one or more partition column sets may further include integrating at least two partition column sets of a plurality of partition column sets for one or more horizontal partitions when the plurality of partition column sets are formed for each of the horizontal partitions.

Yet another embodiment of the present invention provides an apparatus for processing a query including an input/output unit configured to receive the query; and a processor connected to the input/output unit and performing a query processing, wherein the processor is configured to select a horizontal partition corresponding to the received query among horizontal partitions of a data table when the query is received through the input/output unit, to select one or more partition column sets corresponding to the received query when the one or more partition column sets are present in the selected horizontal partition, and to process the query the selected partition column set.

When the data table is divided into one or more horizontal partitions, the partition column sets may be data structures in which a column set obtained by grouping one or more columns configuring the data table for each of the horizontal partitions is stored in a cash table.

One or more partition column sets may be selectively formed for each of the partitions of the data table, and the number of formed partition column sets and the kind of columns forming the partition column sets may be different for each of the partitions.

The processor may be configured to analyze a condition clause of the received query and to select one partition column set of the one or more partition column sets based on a result of the analysis when the one or more partition column sets are formed for the selected partition.

Data blocks corresponding to the horizontal partitions and data blocks corresponding to the partition column sets may be distributed and stored in a plurality of nodes of a distribute file system, and the apparatus for processing the query may process the query by reading the data blocks corresponding to the partition column sets of the horizontal partition corresponding to the received query.

### BRIEF DESCRIPTION OF THE DRAWINGS

FIG. 1 is an illustrative diagram illustrating partition column sets according to an exemplary embodiment of the present invention.

FIG. 2 is a flowchart of a process of configuring the partition column sets according to an exemplary embodiment of the present invention.

FIG. 3 is a flowchart of a method for processing a query according to an exemplary embodiment of the present invention.

FIG. 4 is an illustrative diagram illustrating a process of processing a query according to an exemplary embodiment of the present invention.

FIG. 5 is a block diagram of an apparatus for processing a query according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising”, will be understood to imply the inclusion of stated elements but not the exclusion of any other elements.

Hereinafter, a method and an apparatus for processing a query according to an exemplary embodiment of the present invention will be described with reference to the accompanying drawings.

According to an exemplary embodiment of the present invention, a query is processed using a partition column set in which a database partition and a query column set are integrated.

A partitioning of a database refer to physically divide a table by a small part called a partition. A horizontal partition is a method of dividing data of the table, i.e., record into a plurality of sub-tables based on a value of a specific key column, and methods such as a range partition, a hash partition, and the like are mainly used according to a reference of dividing the record. A vertical partition is a method of dividing the data of the table into the plurality of sub-tables so that each sub-table has columns, which are disjoint sets, which are not overlapped with each other. Here, key columns of an original table are overlapped with all sub-tables. In a case in which the database partition is used, when the query is input, since the data of an entire table is not processed and the query is process using only the database partition necessary for the query, query performance may be increased. In particular, in a case in which distributed data is processed, since costs for transmitting data generated in an intermediate operation of a query tree (an abstract syntax tree (AST), or the like) between nodes is very expensive, unnecessary data is initially filtered using the database partition, thereby making it possible to improve a processing speed.

The query column set refers to physically materialize only columns which are frequently used in clauses of WHERE, GROUP BY, HAVING, and the like of the query by analyzing a query workload, and when an additional query is input, the query processing speed may be increased using the query column set. The query column set is effective for increasing the query processing speed in a system mainly having many online analytical processing (OLAP) calculations such as a structure query language (SQL)-on-Hadoop system. The query column set is distinguished form the horizontal partition in that the query column set does not store all columns.

According to an exemplary embodiment of the present invention, the query is processed by integrating the database partition and the query column set, and specifically, a partition column set structure in which the horizontal partition and the query column set are integrated. A data structure in which the table of the database (also referred to as a data table) is divided into the horizontal partition to be physically stored, and the column set is generated for the divided horizontal partition and is physically stored is provided. Here, the column set for the horizontal partition of the table is referred to as the partition column set.

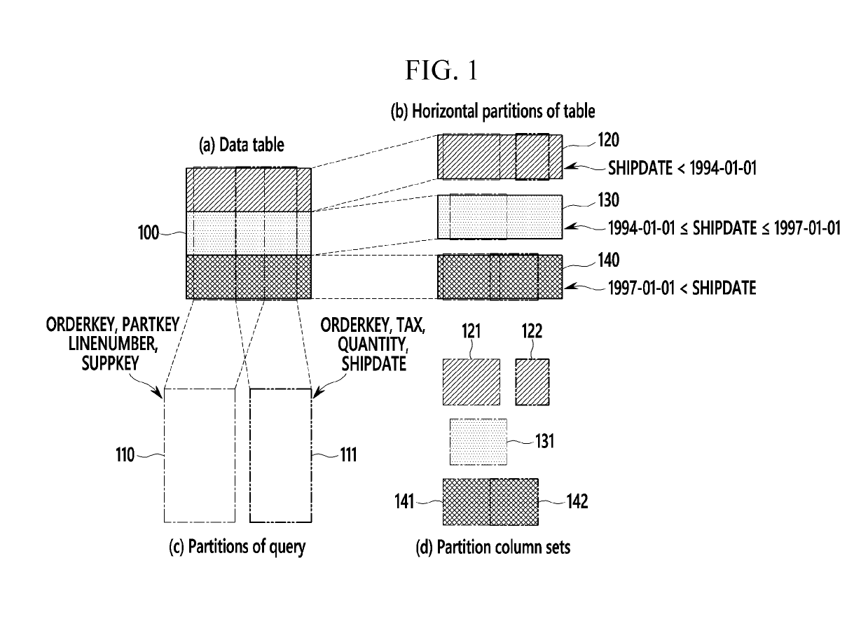

FIG. 1 is an illustrative diagram illustrating a partition column set according to an exemplary embodiment of the present invention.

As illustrated in FIG. 1, partition column sets 121, 122, 131, 141, and 142 are formed for a data table 100 (FIG. 1A).

The data table 100 is divided into horizontal partitions divided so as not overlap with each other and to include all data according to a reference (e.g., a range or a hash value). For example, as illustrated in FIG. 1, the data table may be divided into three horizontal partitions 120, 130, and 140 according to a value of SHIPDATE (FIG. 1B). That is, the data table may be divided into a horizontal partition 1 120 including data in which the value of SHIPDATE is smaller than “1994-01-01, a horizontal partition 2 130 including data in which the value of SHIPDATA is greater than or same as “1994-01-01” and is smaller than “1997-01-01”, and a horizontal partition 3 140 including data in which the value of SHIPDATE is greater than “1997-01-01”.

In addition, query column sets 110 and 111 may be configured for the data table 100. The query column sets are data structures in which column sets which is frequently used for the data table are stored in a cash table. The query column sets are those obtained by grouping and storing columns which are frequently used in clauses such as WHERE, HAVING, and GROUPBY in the query in the data table, and the query column sets of 0 or more may be generated according to the table. For example, for the data table 100, a total of two column sets, which are the query column set 110 for {ORDERKEY, PARTKEY, LINENUMBER, SUPPKEY} and the column set 111 for {ORDERKEY, TAX, QUANTITY, SHIPDATE}, may be configured (FIG. 1B).

As such, according to an exemplary embodiment of the present invention, a partition column set is configured for the data table based on a concept of the horizontal partitions 120, 130, and 140, and the query column sets 110 and 111 which are configured for the data table 100. The partition column set is data in which the query column sets which are frequently used for each of the horizontal partitions of the data table are stored in the cash table. For example, the partition column sets 121, 122, 131, 141, and 142 may be configured by grouping the columns which are frequently used for each of the horizontal partitions 120, 130, and 140 which are configured for the data table 100 (FIG. 1D). When such partition column sets are configured, the number of partition column sets and the kind of columns configuring the column sets may be different according to the partition.

In a case in which the partition column sets are configured as described above, since much unnecessary data may be filtered in advance and processed according to the query in the entire data table, a query processing speed may be increased.

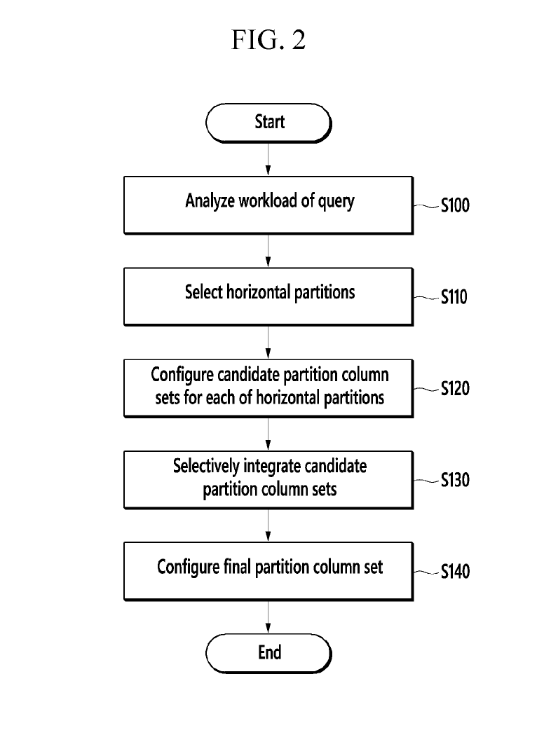

FIG. 2 is a flowchart of a process of configuring the partition column sets according to an exemplary embodiment of the present invention.

Here, an example of configuring the partition column sets in a distribute processing query engine will be described, but the present invention is not limited thereto.

The distribute query processing engine stores a query workload according to a query processing. In order to configure the partition column sets, the query workload is first analyzed (S100) as in FIG. 2 and a candidate horizontal partition is selected (S110). The horizontal partitions are configured for the data table by determining whether the horizontal partition is divided according to any reference based on a result of the query workload analysis, and at least one of the configured horizontal partitions may be selected as the candidate horizontal partition. Alternatively, in a case in which the horizontal partitions are already configured for the data table, one or more of the horizontal partitions which are already configured may be selected as the candidate horizontal partition based on the result of the query workload analysis.

Thereafter, the candidate partition column sets are configured for each of the one or more selected candidate horizontal partitions (S120)

Candidate partition column sets are configured by grouping the columns which are frequently used based on the result of the query workload analysis for each of the candidate horizontal partitions. For example, on the assumption that the column sets that were frequently used in the past will be used later, the candidate partition column set may be configured by grouping the columns corresponding to the corresponding column set.

The candidate partition column sets generated as described above are matched with the query workload, so they quickly process an execution of a specific query, but entire query performance may be rather deteriorated. In a case in which several candidate partition column sets are integrated, the processing of the specific query may be performed less quickly, but the entire query performance may be increased. Therefore, in order to the entire query performance, the several candidate partition column sets are integrated (S130). The partition column set is finally configured by such an integral processing (S140). Meanwhile, the operation (S130) may be selectively performed.

Meanwhile, the number of partition column sets according to an exemplary embodiment of the present invention formed for the horizontal partitions may be 0 or more. That is, one or more partition column sets may be formed for an arbitrary horizontal partition, and the partition column set may not be formed for other horizontal partitions. This may show that one or more partition column sets may be selectively formed for each of the horizontal partitions.

Next, a method for processing a query using the partition column sets configured as described above will be described.

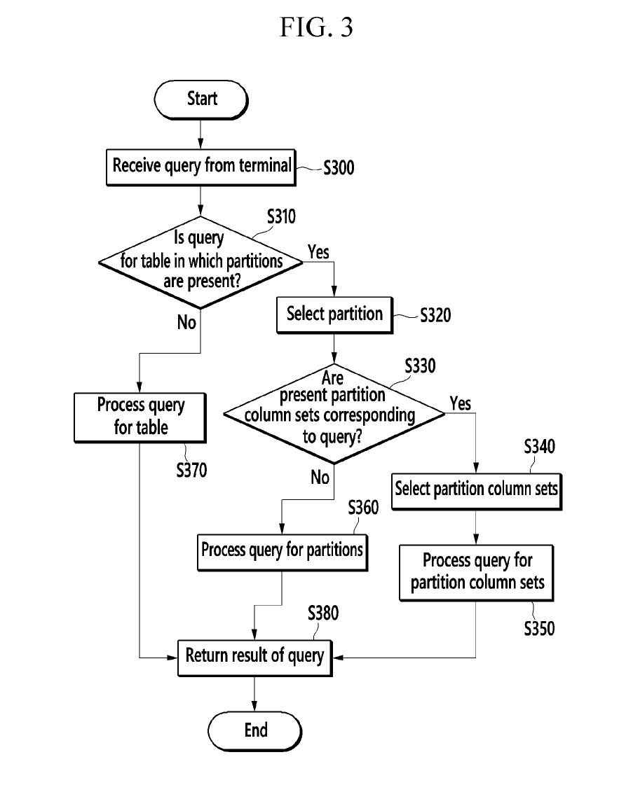

FIG. 3 is a flowchart of a method for processing a query according to an exemplary embodiment of the present invention.

If the query is input from a terminal (S300), the apparatus for processing a query first determines whether data tables corresponding to the query are present in the partition (S310). If the partitions (horizontal partition, or the like) are present in the data table corresponding to the query, the apparatus for processing the query analyzes the query and selects a necessary partition (S320). For example, the apparatus for processing the query analyzes conditional clauses such as WHERE, GROUPBY, HAVING, and the like and selects a partition in which data necessary for the query is present among a plurality of partitions.

Next, the apparatus for processing the query determines whether or not the column sets (e.g., the partition column sets) are present in the selected partition (S330). If the columns sets, for example, the partition column sets are present in the selected partition, the apparatus for processing the query selects a necessary partition column set by analyzing the query (S340). That is, the apparatus for processing the query analyzes the clauses such as WHERE, CGOUPBY, HAVING, SELECT, and the like and selects a necessary partition column set. As such, after the partition is selected and the partition column set is selected for the corresponding partition, the apparatus for processing the query processes the query for the selected partition columns set (S350) and returns a result thereof (S380).

Meanwhile, if the partition column set is not present in the selected partition, the apparatus for processing the query processes the query the selected partition (S360) and returns the result thereof (S380).

Meanwhile, in the operation (S310), if the partitions are not present in the data tables, the apparatus for processing the query processes the query for the data tables (S390) and returns a result thereof (S380).

In the distribute file system such as Hadoop, by a range specified by a user, or the like, the original table is divided into logical partitions and the logical partitions are stored in several nodes to be physically overlapped and distributed. If the query is input, an operation such as a scan or a join needs to be performed only for the partition in which the data necessary for the query is present. Therefore, since only necessary data partitions need to be moved to the node processing the data, unnecessary disk I/O or network transmission may be reduced.

A process of processing the query by applying the partition column sets to the distribute file system will be described below based on the method for processing the query according to the embodiment of the present disclosure.

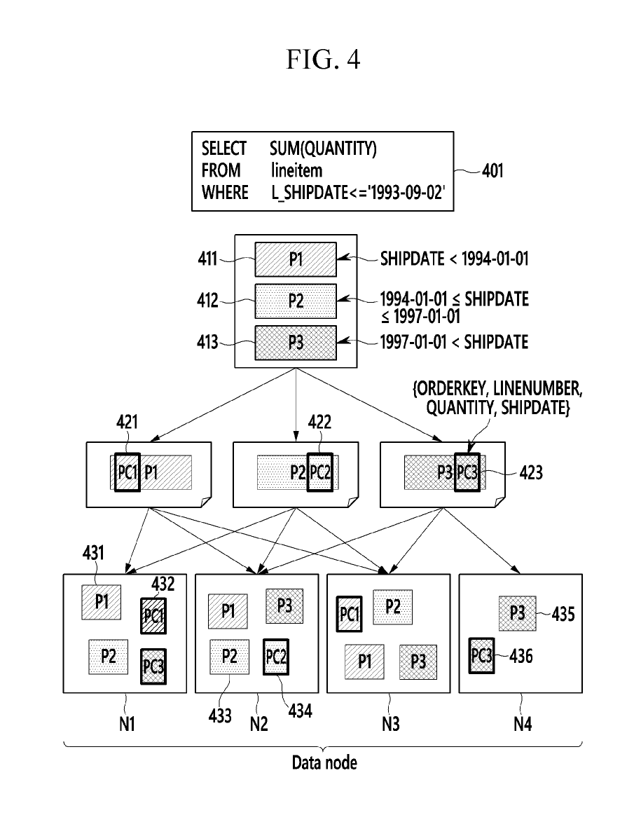

FIG. 4 is an illustrative diagram illustrating a process of processing a query according to an exemplary embodiment of the present invention.

Here, it is assumed that the horizontal partitions and the partition column sets are distributed and stored in several nodes of the distribute file system.

A data table 410 is divided into logical and horizontal partitions according to a reference (a range or a hash value, where SHIPDATE, for example), the horizontal partitions 411, 412, and 413 are divided into data blocks 431, 433, and 435 having a defined size according to a setting of the system to be distributed and stored in several data nodes N1 to N4. Here, the data node refers to the data node of Hadoop. Partition column sets 421 to 423 are configured for each of the horizontal partitions, and the partition column sets 421 to 423 are also divided into data blocks 432, 434, and 436 having a defined size to be distributed and stored.

As such, in a state in which the data blocks corresponding to the horizontal partitions of the data table and the data blocks corresponding to the partition column sets corresponding to each of the horizontal partitions are distributed and stored in the data nodes N1 to N4, if a query 401 is input, the horizontal partition is selected depending on the query. For example, depending on a value of SHIPDATE (1993-09-02) of a WHERE clause of the query 401, since the horizontal partition 411 among the partitions is selected, the partition columns set 421 is present in the selected horizontal partition 411, and the partition column set 421 includes all columns necessary for the query, the query is processed for the partition columns set 421.

In this case, the data node N1 processing the query reads and retrieves the data block 432 for processing the query. Therefore, as compared to costs for reading an entire data table and transmitting the read data table to the corresponding node or reading the corresponding horizontal partition and transmitting the read horizontal partition to the corresponding node, according to an exemplary embodiment of the present invention, since only the partition column sets need to be read and transmitted to the corresponding node, the query processing speed may be increased. In other words, since I/O costs for reading the data and costs for transmitting the data to the node processing the query may be all saved, the query processing speed may be improved. As such, in a case in which the structure of the partition column sets is used, since the data which is not needed in the query is filtered in an initial operation, unnecessary disk I/O or network transmission may be reduced.

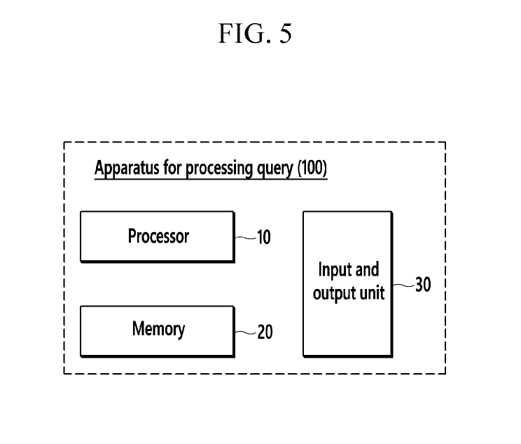

FIG. 5 is a block diagram of an apparatus for processing a query according to an exemplary embodiment of the present invention.

As illustrated in FIG. 5, an apparatus 1 for processing a query according to an exemplary embodiment of the present disclosure includes a processor 10, a memory 20, and an input and output unit 30. The processor 10 may be configured to implement the methods described with reference to FIGS. 1 to 4.

The memory 20 is connected to the processor 10 and stores various information associated with an operation of the processor 10. The memory 20 may store instructions for operations to be performed by the processor 10 or temporarily store the instructions loaded from a storage device (not shown).

The processor 10 may execute the instructions which are stored or loaded in the memory 20. The processor 10 and the memory 20 are connected to each other through a bus (not shown), and the bus may also be connected to an input/output interface (not shown).

The input/output unit 30 is configured to output a processing result of the processor 10 or to receive the query to provide the received query to the processor 10.

According to an embodiment of the present invention, it is possible to improve the query processing speed by processing the query using the partition column sets integrally using the partition and the query column sets. Further, the partition column sets are built up by building up the horizontal partitions for the table of the distributed data and analyzing the query workload for each of the horizontal partitions, thereby making it possible to filter the data processed in the query in advance and to increase the query processing performance.

In particular, in many distribute query process systems, since the online analytical processing (OLAP) calculation reads only the partition column sets corresponding to the query and transmits the read partition column sets to the corresponding node, the query processing speed may be increased.

The exemplary embodiments of the present invention are not implemented only by the apparatus and method described above. Alternatively, the exemplary embodiments may also be implemented by a program for performing functions which correspond to the configuration of the exemplary embodiments of the present invention, a recording medium on which the program is recorded, and the like. These implementations may be easily devised from the description of the exemplary embodiments by those skilled in the art to which the present invention pertains.

While the exemplary embodiments of the present invention have been described in detail, it is to be understood that the invention is not limited to the disclosed embodiments, but on the contrary, is intended to cover various modifications and equivalent arrangements included within the spirit and scope of the appended claims.

What is claimed is:

1. A method for processing a query by an apparatus for processing the query, the method comprising:
when the query is input and partitions are present in a data table, selecting a partition corresponding to the input query;
when one or more partition column sets are present in the selected partition, selecting one or more partition column sets corresponding to the input query; and
processing the query for the selected partition column sets.

2. The method of claim 1, wherein:
when the data table is divided into one or more horizontal partitions, the partition column sets are data structures in which a column set obtained by grouping one or more columns configuring the data table for each of the horizontal partitions is stored in a cash table.

3. The method of claim 1, wherein:
one or more partition column sets are selectively formed for each of the partitions of the data table, and the number of formed partition column sets and the kind of columns forming the partition column sets are different for each of the partitions.

4. The method of claim 3, wherein:
in the selecting of the partition column sets, a conditional clause of the input query is analyzed and one partition column set of the one or more partition column sets is selected based on a result of the analysis when the one or more partition column sets are formed for the selected partition.

5. The method of claim 1, further comprising:
when the partitions are not present in the data table, processing the query for the data table; and
when the partition column sets are not present in the selected partition, processing the query for the selected partition.

6. The method of claim 1, wherein:
the apparatus for processing the query is a distribute query processing engine.

7. A method for configuring a column set for processing a query, the method comprising:
analyzing a workload of the query to divide a data table into a plurality of horizontal partitions; and
selectively configuring one or more partition column sets obtained by grouping one or more columns configuring the data table, based on a result of the analysis of the workload of the query for each of the horizontal partition.

8. The method of claim 7, wherein:
the number of formed partition column sets is different for each of the horizontal partitions.

9. The method of claim 7, wherein:
the kind of columns configuring the partition column sets is different for each of the horizontal partitions.

10. The method of claim 7, wherein:
the configuring of the one or more partition column sets includes storing the partition column sets in a cash table.

11. The method of claim 7, wherein:
the configuring of the one or more partition column sets further includes:
integrating at least two partition column sets of a plurality of partition column sets for one or more horizontal partitions when the plurality of partition column sets are formed for each of the horizontal partitions.

12. An apparatus for processing a query; the apparatus comprising:
an input/output unit configured to receive the query; and
a processor connected to the input/output unit and performing a query processing,
wherein the processor is configured
to select a horizontal partition corresponding to the received query among horizontal partitions of a data table when the query is received through the input/output unit, to select one or more partition column sets corresponding to the received query when the one or more partition column sets are present in the selected horizontal partition, and to process the query the selected partition column set.

13. The apparatus of claim 12, wherein:
when the data table is divided into one or more horizontal partitions, the partition column sets are data structures in which a column set obtained by grouping one or more columns configuring the data table for each of the horizontal partitions is stored in a cash table.

14. The apparatus of claim 12, wherein:
one or more partition column sets are selectively formed for each of the partitions of the data table, and the number of formed partition column sets and the kind of columns forming the partition column sets are different for each of the partitions.

15. The apparatus of claim 14, wherein:
the processor is configured to analyze a condition clause of the received query and to select one partition column set of the one or more partition column sets based on a result of the analysis when the one or more partition column sets are formed for the selected partition.

16. The apparatus of claim 12, wherein:
data blocks corresponding to the horizontal partitions and data blocks corresponding to the partition column sets are distributed and stored in a plurality of nodes of a distribute file system, and
the apparatus for processing the query processes the query by reading the data blocks corresponding to the partition column sets of the horizontal partition corresponding to the received query.
